(19) United States
(12) Patent Application Publication
(10) Pub. No.: US 2005/0164773 A1
(43) Pub. Date: Jul. 28, 2005

(54) Method, system, and program product for bonus round play in networked bingo games

(75) Inventors: Clifton E. Lind, Austin, TX (US); Jefferson C. Lind, Austin, TX (US); Joseph R. Enzminger, Austin, TX (US)

Correspondence Address: THE CULBERTSON GROUP, P.C., 1114 LOST CREEK BLVD., SUITE 420, AUSTIN, TX, 78746, US

(73) Assignee: Multimedia Games, Inc.

(21) Appl. No.: 11/039,668

(22) Filed: Jan. 20, 2005

Related U.S. Application Data
(60) Provisional application No. 60/538,337, filed on Jan. 22, 2004.

(51) Int. Cl. A63F 13/00

(52) U.S. Cl. 463/19

(57) ABSTRACT

Methods, apparatus, and program products are described for conducting a networked bingo game for a number of game play requests to identify bingo game results, including at least one bonus round result. A number of selection options are presented to a player with the bonus round result (the bonus round player) and one or more selection options are associated with a respective bonus prize. After presenting the bonus round player with the selection options, the player is enabled to choose at least one of the selection options. The bonus round player is then awarded the bonus prize associated with the chosen selection option.

### CROSS-REFERENCE TO RELATED APPLICATION

The Applicants claim the benefit, under 35 U.S.C. § 119(e), of U.S. Provisional Patent Application No. 60/538,337 filed Jan. 22, 2004 and entitled “Method, System, and Program Product for Bonus Round Play in Networked Bingo Games.” The entire content of this provisional patent application is incorporated herein by this reference.

### TECHNICAL FIELD OF THE INVENTION

This invention relates to electronic gaming systems that enable players to participate in bingo games, including bingo games that enable a player to win a bonus prize. More particularly, the invention is directed to apparatus, methods, and program products where a player may be presented with the opportunity to choose a prize from among a number of prizes in a bonus portion of a bingo game.

### BACKGROUND OF THE INVENTION

The game referred to generally as “bingo” is played with predetermined bingo cards having designations, such as numbers, letters or other symbols, randomly arranged in a grid or other layout on a bingo card. The locations of such designations on a bingo card are sometimes referred to as spots. Bingo cards may be physically printed on paper or another suitable material, or may be represented by a data structure that defines the various locations and the designations associated with the locations. In a traditional bingo game sequence, a number of predetermined bingo cards are put in play for a particular game. After the sale of bingo cards is closed for a given game, designations are randomly selected from a pool of available designations, such as by drawing marked balls from a tumbler. The selected designations are then matched to the designations on each bingo card that is in play for the game. This matching, which is commonly referred to as “daubing” the card, results in a pattern of matched spots for each card in play in the game. In traditional bingo games daubing was done manually by the player holding the bingo card. If the player's daubing resulted in a predetermined winning pattern of matched card locations, the player announced the win or “bingo” and the card was again daubed by a game administrator in order to verify the winning pattern. More recent bingo game systems automatically check for winning patterns on a bingo card as designations are randomly selected for a game. This automated daubing may be in lieu of or in addition to daubing by the player.

Some traditional bingo games incorporated bonus round play for players achieving a predetermined pattern in the underlying bingo game. This type of bingo game has been referred to as a “pick-a-pet” game. According to this bonus play, a player achieving a predefined “pick-a-pet” pattern in the bingo game was given the opportunity to pick from some number of objects such as stuffed animals. In order to increase player interest in bonus game play, a monetary prize or some other prize could be hidden inside one or more of the objects from which the bonus player could choose. The player playing the “pick-a-pet” bonus round received the object they select along with any other prize associated with the selected object.

Although traditional paper bingo games and corresponding bonus games remain popular, the speed with which such traditional games are played is often an issue among today's players, who are increasingly accustomed to more fast-paced entertainment. That is, certain steps in the traditional paper bingo game are relatively time consuming. These include time allotted for card purchasing (the buy-in period), followed by a period for drawing a sequence of balls and individually announcing the drawn designations, followed by a period to allow players to manually daub their card or cards, and then a time for winner verification. Additional time was needed for the bonus game in order to present the bonus game player with the objects from which they could choose and allow them to make a selection. The time required to play a traditional bingo game and an associated bonus game tends to limit player excitement and satisfaction.

Various systems have been developed to aid players in playing bingo games and to enhance player participation in the games. Some of these gaming systems allow players at different gaming facilities, which may be spaced apart over a large geographic area, to participate in bingo games through electronic player stations maintained at the various gaming facilities.

The manner is which electronic bingo gaming systems conduct bingo games may allow the players to receive results very quickly. The speed with which results are returned to the players and other aspects of the systems give these systems a great deal of flexibility in presenting the results to the players. However, there remains a need to enhance player involvement in electronically implemented bingo gaming systems and to further increase player satisfaction with the games.

### SUMMARY OF THE INVENTION

The present invention provides a method, apparatus, and program product for facilitating bonus round play in a networked electronic bingo gaming system. One preferred method according to the invention includes conducting a networked bingo game to identify a number of bingo game results, including at least one bonus round result. The bonus round result is associated with a game play request initiated through a player station. The method also includes presenting a number of selection options through a display device associated with the player station. After presenting the selection options, the method includes enabling a player to choose at least one of the selection options. The method then includes presenting a bonus prize to the player at the player station. This bonus prize is associated with the selection option chosen by the player.

In some preferred forms of the invention, bonus prizes are randomly or pseudo-randomly associated with the various selection options and hidden from the player at the time the player makes their selection. In these forms of the invention, the player's choice from among the various selection options presented to them actually affects the bonus prize they receive for their participation in the bingo game.

The player's selection options can be presented to the player in a large variety of ways within the scope of the invention. In one embodiment, the player may be presented with a number of graphic representations of stuffed animals displayed on a display device associated with the player's player station. The player may make his or her choice in this arrangement by using a touch screen input or some other input indicating a particular one or more of the graphic representations. The player would then receive any bonus prize associated with the chosen graphic representations. An alternative arrangement for presenting selection options to a player may comprise displaying a number of closed doors on a display device associated with the player's player station. The player would make his or her choice from among these representations using a suitable input device associated with the player station. Once the choice is made, the selected graphic representation would change to show the door opening to reveal a prize to be awarded to the player. In yet other selection option presentation arrangements the player may be asked via an interactive display arrangement to answer a multiple choice trivia question. Each potential answer would represent a selection option and be associated with a respective prize. In any of these preferred arrangements, requiring the player to make a choice to reveal their bonus prize makes the player's experience more interactive and enhances player involvement in the game.

A system according to the invention may include a number of player stations (also referred to herein as “electronic player stations”), each having a respective display device and display controller, and each being connected to a bingo game processor over a communications network. The bingo game processor may be a single computer or several computers at different locations that conduct a bingo game for a number of bingo game play requests to identify a respective bingo game result for each respective game play request. At least one of the bingo game results comprises a bonus round result. The bingo game processor also causes the respective bingo game result to be communicated to the player station from which the respective game play request was received. When a bonus round result is received at a given player station the respective display controller associated with the player station causes the display device associated with that player station to present a number of selection options, and to display a bonus prize associated with one of the selection options chosen by the player at the respective player station.

The invention may be implemented through a program product stored on one or more computer readable media and adapted to be executed by the various processing devices included in the system. One particular program product according to the invention includes bingo game program code, display program code, and player selection program code. The bingo game program code is adapted to be executed to conduct a bingo game for a number of game play requests and to identify a respective bingo game result for each respective game play request, at least one of which comprising a bonus round result. The display program code is adapted to be executed to direct a display device associated with the player station to display a number of selection options and to direct the display device to display a bonus prize associated with a selection option chosen by a player at the player station as detected by the player selection program code.

These and other advantages and features of the invention will be apparent from the following description of preferred embodiments, considered along with the accompanying drawings.

### BRIEF DESCRIPTION OF THE DRAWINGS

FIG. 1 is a diagrammatic representation of a bingo gaming system with which the present invention may be implemented.

FIG. 2 is a diagrammatic representation of a computer system arrangement that may be used for the central game server and local area servers included in the system shown in FIG. 1.

FIG. 3 is a diagrammatic representation of an electronic player station that may be used in the system shown in FIG. 1.

FIG. 4 is a diagrammatic representation of an embodiment of the present invention as implemented with the system shown in FIG. 1.

FIG. 5 is a diagram providing a description of a process embodying the principles of the present invention.

FIG. 6 is a representation of a player station display that may be used to communicate a bingo game result to a player where the bingo game result is not associated with bonus round play.

FIG. 7 is a representation of a player station display of selection options in a bonus game according to one embodiment of the invention.

FIG. 8 is a representation similar to FIG. 7, but showing the actual bonus prize revealed to the player.

### DESCRIPTION OF PREFERRED EMBODIMENTS

The invention, a preferred mode of use, and further advantages and features of the invention, will best be understood by reference to the following detailed description of illustrative embodiments read in conjunction with the accompanying drawings.

The present invention may be used to provide bonus round play in many different types of networked bingo gaming systems. The following description of the present invention will be made in reference to a particular bingo gaming system disclosed fully in U.S. patent application Publication No. 2004/0152499 A1 entitled “Method, System, and Program Product for Conducting Multiple Concurrent Bingo-Type Games,” the entire content of which is incorporated herein by this reference. However, it should be noted that the invention is not limited to any particular networked bingo gaming system. Rather, the invention may be used in connection with any networked bingo gaming system utilizing player stations to present results to the participants in bingo games.

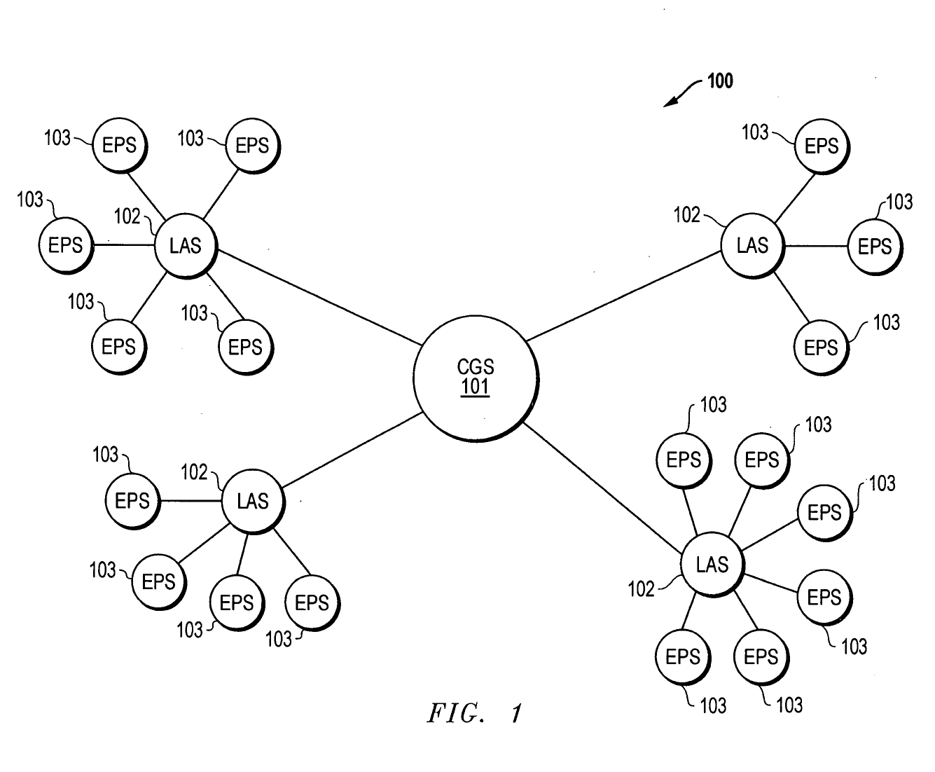

FIG. 1 shows a gaming system 100 including a central game server (CGS) 101 that cooperates with a number of other components to enable bingo players, preferably at many different remote gaming sites, to participate in bingo games. Each gaming site includes a local area server (LAS) 102 and a number of electronic player stations (EPSs) 103. In the normal operation of gaming system 100, a player at any EPS 103 in the system may participate in a given bingo game with players at any other EPSs 103 in the system. Thus, players at different gaming facilities may be grouped together for a given bingo game administered through system 100. Grouping together players from different gaming facilities for the play of a bingo game allows different bingo games to be played rapidly and minimizes the time that players must wait to receive the result of their participation in the bingo game.

System 100 includes an arrangement for grouping players for the play of a single bingo game to facilitate rapid play. System 100 reduces the time between a game play request at one of the EPSs 103 and the return of results to the respective EPS sufficiently to allow a great deal of flexibility in how results in the bingo game are displayed to the player. In particular, the bingo game results may be displayed in some manner unrelated to bingo. For example, the bingo game results may be mapped to a display traditionally associated with a reel-type game (slot machine), to a display relating to a card game, or to a display showing a race such as a horse or dog race, for example. Preferred techniques for mapping bingo game results to displays associated with games or contests unrelated to bingo are described in U.S. patent application Publication No. 2002/0132661 A1 entitled “Method, Apparatus, and Program Product for Presenting Results in a Bingo-Type Game.” The entire content of this prior application is incorporated herein by this reference. With regard to the present invention, the system allows a bingo game result to be displayed as a bonus round that allows the player to have enhanced interaction with the gaming system.

System 100 rapidly groups players and starts one game after another so that multiple games may be in play at any given time. That is, once a first group of players has been assigned to participate in a bingo game offered through system 100, the system proceeds to simultaneously administer a bingo game for the first group of players and also begin grouping players for a next bingo game. System 100 does not necessarily wait for one bingo game to be completed before starting to collect players for and actually beginning play in the next bingo game. The number of players grouped for the play of bingo games according to the present invention may be limited to reduce the time required for grouping players. For example, each bingo game offered through gaming system 100 shown in FIG. 1 may be limited to between 2 to 20 players, with the preferred number of players for any given game being from 10 to 15. Where system 100 includes numerous EPSs 103 at the various remote locations, on the order of several thousand EPSs for example, hundreds of individual bingo games may be in progress at any given time through the gaming system.

Regardless of the rapid play facilitated by system 100 and regardless of the manner in which the bingo game results are displayed, the underlying game remains a standard bingo game played in the traditional sequence of play for bingo games. That is, each player obtains or is assigned a bingo card or bingo card representation, all bingo cards in play in the game are daubed or checked for matches with a randomly generated sequence of designations (for example, designations produced in a ball draw or produced by a random number generator), and the first card in the game to match the sequence of designations to produce the game ending pattern wins the bingo game. Additional prizes may be awarded for other patterns that may be produced in the course of the bingo game. The mapping of different prizes to various bingo patterns that may be produced in the course of a bingo game in system 100 may be accomplished as described in U.S. Pat. No. 6,569,017, entitled “Method for Assigning Prizes in Bingo-Type Games” or U.S. patent application Publication No. 2004/0048647 A1 entitled “Prize Assignment Method and Program Product for Bingo-Type Games.” The entire content of each of these prior documents is incorporated herein by this reference.

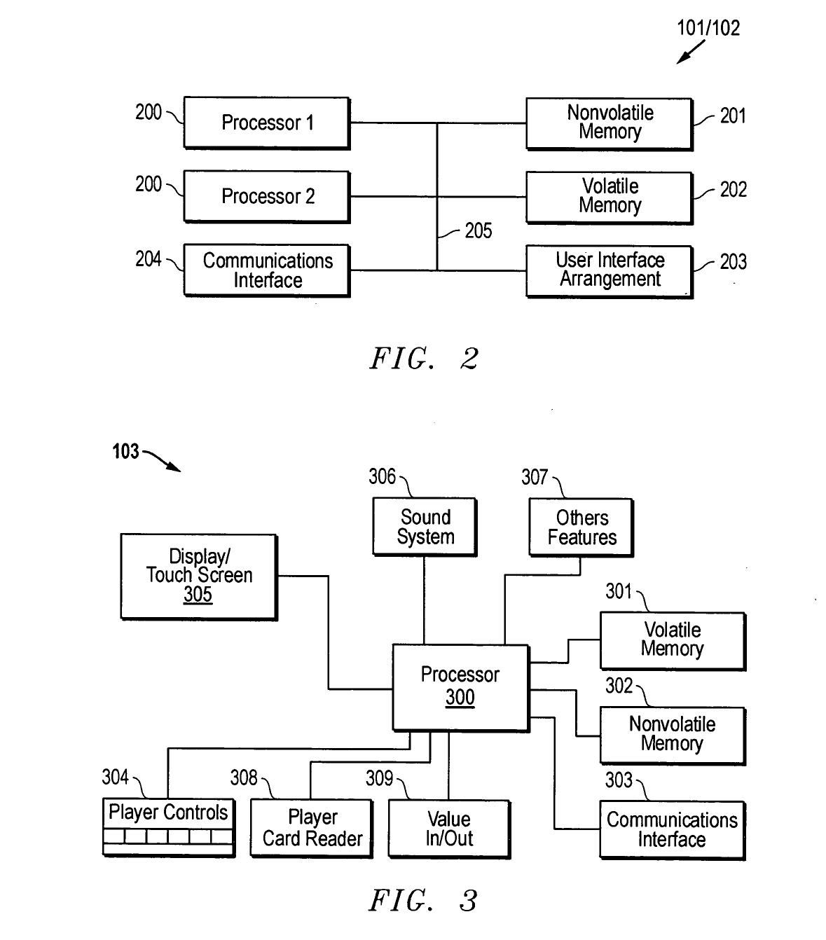

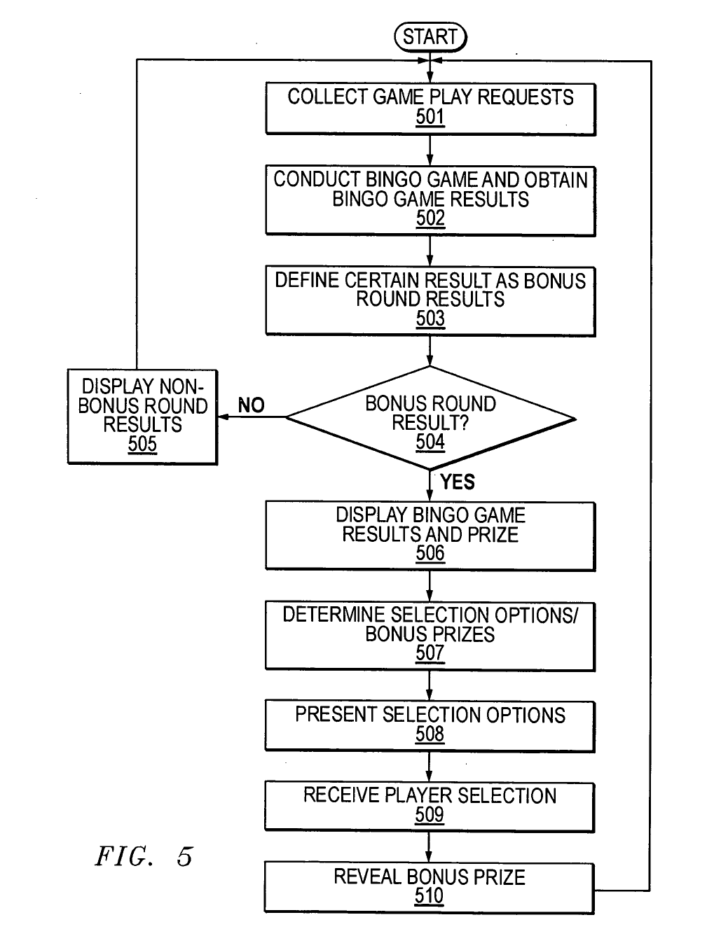

CGS 101 may comprise a computer system such as the basic system shown in FIG. 2. The basic system may include one or more processors 200, nonvolatile memory 201, volatile memory 202, a user interface arrangement 203, and a communications interface 204, all connected to a system bus 205. It will be appreciated that user interface arrangement 203 may include a number of different devices such as a keyboard, a display, and a pointing device such as a mouse or trackball for example. It will also be appreciated that each of these user interface devices will commonly include its own interface to the computer system, although not shown in FIG. 2. Alternatively to the integrated user interface arrangement 203 shown in FIG. 2, a user interface for CGS 101 may be provided through a separate computer (not shown) in communication with the CGS. Regardless of the particular configuration for CGS 101, in the normal operation of system 100 shown in FIG. 1, the CGS functions as a bingo game processor to group players for participation in bingo games offered through the system, produce or obtain sequences of designations (ball draws, for example) for the play of the bingo games, check for the results in the bingo games, and communicate the bingo game results to LASs 102. In addition, CGS 101 may also participate in providing bonus round play according to the present invention as will be described in more detail below with reference to FIG. 5. In particular, CGS 101 may serve a bonus prize controller, or may interface with a database to provide bonus round prizes.

As used in this disclosure, any sequence of designations that may be matched against bingo cards in the present gaming system will be referred to as a “ball draw” regardless of how the sequence is actually generated. Under this definition, it will be appreciated that a ball draw may be produced by a random number generator, a pseudo random number generator, or any other suitable device or system, and not necessarily a physical ball draw device.

Each LAS 102 included in system 100 as shown in FIG. 1 may comprise a computer system having the same basic structure as shown in FIG. 2. That is, each LAS 102 may include one or more processors 200, nonvolatile memory 201, volatile memory 202, user interface arrangement 203, and communications interface 204 all connected to system bus 205. As with CGS 101, the user interface for the respective LAS 102 may be provided through a separate computer in communication with the LAS rather than the integrated user interface arrangement 203 shown in FIG. 2. Regardless of the specific configuration of the LAS 102, each LAS serves, in normal operation of the system shown in FIG. 1, to transfer or relay information from its respective EPSs 103 to CGS 101 and transfer or relay information from the CGS to the LAS's respective EPSs. Each LAS 102 according to the present invention may also have the ability to group players and actually play bingo games in certain situations and thus function as a bingo game processor and participate in providing bonus round play according to the invention. For example, where one LAS 102 serves a large number of EPSs 103, the LAS may group players from its respective EPSs during a time of high player activity, obtain or produce a ball draw, detect the bingo game results, return results to the EPSs, and facilitate bonus round play, if necessary, rather than having the CGS 101 perform these tasks. Also, each LAS 102 shown in FIG. 1 may be configured to perform the tasks normally performed by CGS 101 in the event the communications link between the respective LAS and CGS is degraded below a certain level or is severed altogether.

FIG. 3 shows an example of an EPS 103 that may be used in a gaming system embodying the principles of the present invention. The illustrated EPS 103 includes a processor 300, volatile memory 301, nonvolatile memory 302, and a communications interface 303. The volatile and nonvolatile memory stores computer program code that may be executed by processor 300 to cause the processor to perform or direct the various functions provided by EPS 103. Communications interface 303 allows communications between EPS 103 and its respective LAS 102 and/or CGS 101. EPS 103 also includes a user interface arrangement to facilitate player participation in the bingo games offered through gaming system 100 shown in FIG. 1, and display results in an exciting and attractive format. In particular, the user interface arrangement associated with EPS 103 facilitates the play of the underlying bingo game and participation in one or more bonus rounds according to the present invention. A preferred user interface includes player controls 304, a display device or touch screen display device 305, a sound system 306, and perhaps other features 307 such as alarms or special displays or alerting devices. Each EPS 103 also preferably includes a convenient system for allowing the player to input player-specific information and for receiving wagers and dispensing winnings. For example, the EPS 103 shown in FIG. 3 includes a player card reader 308 that is adapted to read player-specific information from a player account card inserted into the reader. A player account card may, for example, include player information or simply a player identifier encoded on a magnetic medium (mag stripe) associated with the card, or encoded in a bar code, or a memory device associated with the player account card. The illustrated EPS 103 also includes a device 309 for receiving value and issuing value in the course of play. This device may accept currency, vouchers, or tokens, for example, and also output currency, vouchers, or tokens. Of course a separate device may be used to receive and issue value for games played according to the present invention. Alternatively or in addition to value in/out device 309, EPSs 103 may read player account information from the player account card or player information otherwise input at the EPS, and account for wagers and winnings in the manner set out in U.S. Patent Application Publication No. 2002/0132666 Al entitled “Distributed Account Based Gaming System,” the entire content of which is incorporated herein by this reference.

It will be appreciated that the particular configuration of devices shown in FIG. 1 is shown only for purposes of example. A bingo gaming system that may be used in an implementation of the present invention may omit some or all of the separate LASs 102 at the various gaming facilities so that the EPSs 103 communicate directly with CGS 101. Also, various regions or different gaming facilities may be divided up into separate systems each having a respective CGS such as CGS 101. In these situations the system could be configured such that a single EPS 103 may be serviced by any of the CGSs. Furthermore, a gaming system embodying the principles of the invention may include multiple CGSs rather than a single CGS 101 as shown in FIG. 1.

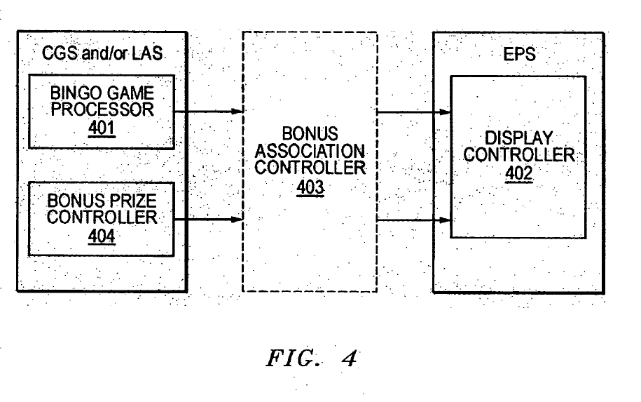

FIG. 4 may be used to describe the components of one embodiment of the present invention as implemented in connection with gaming system 100. The illustrated gaming system includes a bingo game processor 401 and a display controller 402. Bingo game processor 401 produces, obtains, or identifies a bingo game result in a bingo game conducted for a number of game play requests. Display controller 402 causes the display device (such as display 305 in FIG. 3) associated with an EPS 103 to produce graphics that present to the player the bingo game results. Display controller 402 also may cause the display device to facilitate bonus round play and present the player with a number of selection options from which to choose during bonus round play conducted according to the present invention. Once a player is in bonus round play, bonus prizes associated with the selection options are concealed from the player until the player chooses one of the selection options. At this point, display controller 402 causes the display device to reveal the bonus prize associated with the selection option chosen by the player. In connection with bingo game results that are not associated with a bonus game, that is, in connection with non-bonus round results, display controller 402 may cause the display device to display the non-bonus round result to the player immediately in response to receipt of the non-bonus round result without presenting any of the selection options that would be presented for a bingo game result comprising a bonus round result.

The various selection options presented to a bonus round player under the control of display controller 402 may be associated with particular bonus prizes by a bonus prize controller 404. This bonus prize controller 404 may select bonus prizes from a preferably randomized pool of potential bonus prizes for associating with various selection options. Alternatively, bonus prize controller 404 may perform a look-up in a suitable data table to locate bonus prizes that are preassociated with the various selection options available for given bonus round play. For example, a particular result in the underlying bingo game may not only be predefined as a bonus round result, but also predefined as providing a certain number of selection options with a certain bonus prize anonymously associated with each selection option. Continuing with this example, a bonus round data table may correlate a particular bingo game result with a set of player five selection options in a bonus round and may dictate that bonus prizes of 5 credits, 10 credits, 15 credits, 20 credits, and 25 credits are the available bonus prizes, all anonymously associated with the various selection options so that the player will not know which selection option will provide which bonus prize. Alternatively to selecting a predefined set of potential bonus prizes, bonus prize controller 404 may select a separate potential bonus prize for each selection option to be presented to the player. the bingo game which was defined as a bonus round result. In yet other forms of the present invention, a bingo game may be conducted to determine one or more potential bonus prizes to be associated with the player's different selection options in bonus round play. For example, one or more of the bingo results identified in the underlying bingo game producing a bonus round result may be compared against a potential bonus prize definition table which correlates various bingo game results to various potential bonus prizes or sets of potential bonus prizes. Alternatively, a separate bingo game may be conducted by bingo game processor 401 or by bonus prize controller 404.

In system 100, bingo game processor 401 and bonus prize controller 404 are implemented in CGS 101 and/or an LAS 102 depending upon the configuration of the system and the mode of operation at the particular time. That is, either CGS 101 or LASs 102, or both at different times, may be capable of identifying bingo game results in system 100, as described more fully in U.S. patent application Publication No. 2004/0152499 A1, which is already incorporated by reference herein. Display controller 402 may be implemented in an EPS 103 in system 100. In particular, display controller 402 may be implemented through software code and processing hardware at EPS 103 used to control the images produced on the display device (305 in FIG. 3) associated with the EPS. Thus, FIG. 4 shows display controller 402 included in an EPS 103.

A “bingo game result” according to the present invention comprises any identifier or data representing the result of a bingo game for a particular game play request. The particular form of the bingo game result and the manner in which it is communicated to display controller 402 is subject to wide variation within the scope of the present invention. A bingo game result may be a code or index value that is correlated to a result definition at the player station. For example, bingo game processor 401 may communicate a bingo game result in the form of a coded value and the EPS 103 may query a locally stored look-up table,to identify the value associated with the bingo game result, identify the specific bingo pattern achieved in the play of the underlying bingo game, and perhaps symbols or alternative symbols that may be used to display the bingo game result to the player. Alternatively, bingo game processor 401 may communicate a bingo game result in the form of a set of data specifying the value associated with the bingo game result, the bingo pattern achieved in the bingo game, and symbols to be used to reveal the bingo game result to the player. Bingo game results may be communicated from bingo game processor 401 in substantially any form that allows EPS 103 and display controller 402 to perform their functions according to the invention.

Similarly, the specific way in which a display controller 402 operates to perform the display control function is not critical to the present invention. Although display controller 402 is shown implemented with hardware included in an EPS 103 in FIG. 4, those skilled in the art will appreciate that the functions of a display controller may be performed using any number of software techniques and hardware arrangements. For example, all of the processing required to produce the signals used to generate the actual images on the display device may be performed at some location remote to the player station and communicated to the player station through a cable or some other signal communication arrangement.

FIG. 4 also illustrates a bonus association controller 403 interposed between bingo game processor 401 and display controller 402. A bonus association controller such as that shown at 403 in FIG. 4 may be employed in some forms of the present invention to define a given bingo game result from bingo game processor 401 as a bonus round result according to the present invention. This definition of a game play result as a bonus round result may be performed in many different ways within the scope of the present invention. In one embodiment the definition is made in a random fashion, such as for a randomly selected time of day. In another embodiment, a bingo game result is defined as a bonus round result after a randomly determined number of games that a player or a player pool has played. In an additional embodiment, a bingo game result is defined as a bonus round result after a randomly determined amount of winnings or losses for a player or a pool of players. In still another embodiment, a bingo game result is defined as a bonus round result, and is thus associated with bonus round play, at a particular time of day for a particular player station according to a predetermined schedule of elapsed times, such as elapsed playing time, or a predetermined schedule of times of day. In other embodiments, the bonus round results are defined according to a predetermined number of games played on a player station, or by a particular player, or player pool. In yet other embodiments of the present invention, bonus association controller 403 may define bingo game results as bonus round results according to some predefined relationship. For example, gaming system 100 in FIGS. 1 and 4 may be programmed in advance to provide bonus round play with each occurrence of an “X” pattern, or a “T” pattern, etc. on the respective player's bingo card. It should be noted that entry into bonus round play does not have to be based on a player achieving the game ending pattern, but any predetermined pattern associated with a player's bingo card. According to this example, bonus association controller 403 may utilize a look-up table in which certain types of bingo game results are defined as bonus round results.

In some embodiments of the present invention the definition of a bingo game result as a bonus round result may be done prior to the generation or identification of results. That is, implementations of the invention may simply define certain results possible in the underlying bingo game as bonus round results. In this case, the bingo game result is associated with a bonus round play without any affirmative action in the gaming system other than the generation or identification of the given result. These implementations of the invention will include no bonus association controller element considering that certain bingo game results are predefined as bonus round results.

A method according to the invention may be described with reference to the diagram of FIG. 5. In the following description of FIG. 5 it will be appreciated that the references to the physical components are references to the diagrams in FIGS. 1, 2, 3, and 4 that show those components. The illustrated process begins with collecting game play requests as shown at process block 501. The various game play requests are submitted from player stations such as an EPS 103 in FIG. 1. The system responds to the game play requests by conducting a bingo game to identify a bingo game result for each game play request included for a bingo game as shown at process block 502 in FIG. 5. This step may be performed by any suitable bingo game processor such as CGS 101 and/or LAS 102 as described above and in the previously referenced and related patent application Publication No. 2004/0152499 A1. The process may also include a step such as that shown at process block 503 of defining at least some results as bonus round results as described above in connection with bonus association controller 403 in FIG. 4. If the respective bingo game result is not a bonus round result (a non-bonus round result) as indicated by a negative result at decision block 504, the player station display device of the player station associated with that game play request shows or displays the game play result to the player as indicated at process block 505, and then the process returns to collect additional game play requests to conduct another bingo game. It will be noted that numerous instances of the process shown in FIG. 5 may be in progress at any given time and that the system preferably does not wait for the completion of a game and display of results before starting another instance.

In a preferred embodiment of the invention, for any bingo game result comprising a bonus round result, the process may include presenting the respective bingo game result to the respective player, displaying any prize associated with the underlying bingo game result, and notifying the player that they will be participating in, or have the opportunity to participate in, bonus round play as shown at dashed process block 506. It will be appreciated that some implementations of the invention may not perform the step or steps indicated at process block 506. Regardless of whether the steps shown at block 506 are performed, the invention includes presenting a number of selection options as indicated at process block 507, one or more of the selection options being associated with a bonus prize. This step is preferably performed separately for each bonus round result, although some forms of the invention may associate each bonus round result in a given game with a common set of selection options. The production or identification of bonus prizes may be performed using a variety of methods as described above with reference to the bonus prize controller 404 shown in FIG. 4. For example, the system may select bonus prizes from a randomized pool, similar to a lottery pool, the bonus prizes may be fixed based on the respective result of the bingo game, or one or more bonus prizes may be determined by conducting a separate bingo game.

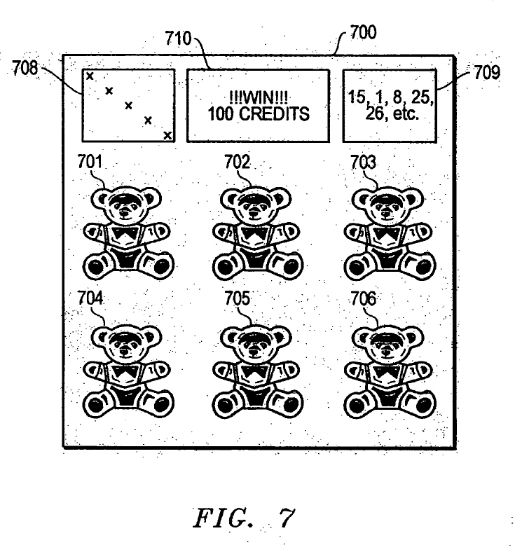

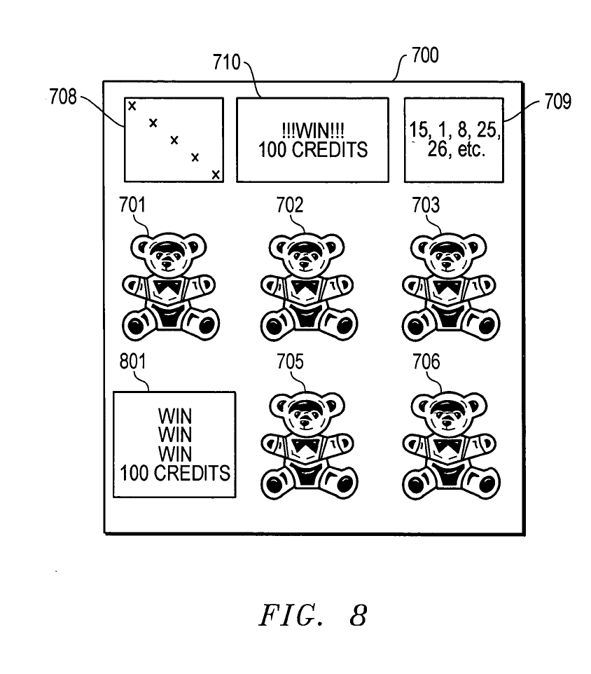

Although bonus prize controller 404 is shown in FIG. 4 associated with either CGS 101, or an LAS 102, it will be appreciated that the controller may be implemented with a processor located at the respective EPS 103 under the control of the bonus prize program code. If CGS 101 or an LAS 102 select the bonus prizes, the bonus prize program code also directs the communication of the bonus prizes to the respective EPS 103. In any case, once the bonus prizes are determined and the number of selection options are determined, the selection options are presented to the player such that the bonus prize associated with each option is not revealed to the player. This process of presenting selection options is shown at block 508 in FIG. 5 and will be described further with reference to FIGS. 7 and 8 below. After the system receives the player's choice of one or more of the selection options in the step indicated at block 509, the process includes presenting the bonus prize associated with the player's selection as shown at process block 510. From this point, the process returns to collect game play requests for another bingo game. Again, it should be noted that the steps shown at 506, 507, 508, 509, and 510 are steps performed for each bonus round result achieved in the bingo game. The steps are preferably independent between the various bonus round results at least in that each respective player station displays the selection options independently of the other player stations and responds to the player's choice independently. However, certain aspects of the steps may be common among the various players and player stations within the scope of the invention. For example, each player in bonus round play for a given game may be presented the same selection options, in the same way, with the same set of bonus prizes.

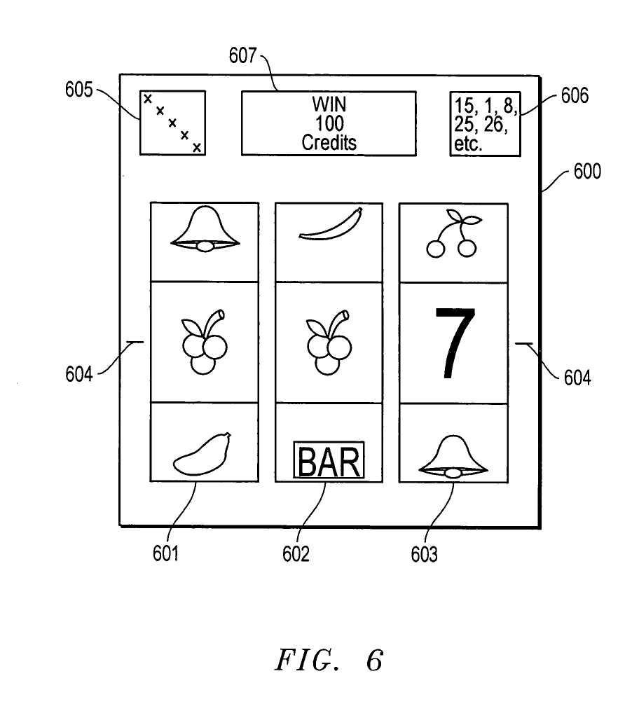

FIG. 6 provides an example of a graphical presentation 600 that may be used to display to a player a bingo game result that does not comprise a bonus round result. The illustrated graphical presentation 600 may be generated under control of display controller 402 in FIG. 4 and includes a representation of a series of three reels 601, 602, and 603. These reels correspond to the reels of a reel-type game or slot machine and are represented as having various symbols at various reel locations. The symbols displayed in a line such as line 604 are correlated through some payout table with a bingo game result in the bingo game. That is, a particular level of a win in the game may be related to the player by showing some predefined set of reel symbols across line 604. Graphical presentation 600 also includes an area 605 in which the achieved pattern may be displayed. Area 606 may be used to display a “flash board” for the underlying bingo game, that is, the series of numbers called in the bingo game. Area 607 may be used to display animated graphics or other graphics such as the amount of credits won based on the bingo game result. It should be noted that although a particular bingo game result is not associated with bonus round play, that particular bingo game result is not precluded from being associated with some kind of prize. For example, as shown in FIG. 6, a result associated with the two cherry symbols and the number “7” symbol along payline 604 may result in a prize of 100 credits, even though that result is not a bonus round result and does not qualify the player for bonus round play. However, not all reel symbol combinations across payline 604 are associated with a prize. If a bingo game result is not associated with a prize, area 607 may display a message stating that the player has not won a prize and encouraging them to play again.

FIG. 7 illustrates a graphical presentation 700 that may be used in a bonus round embodying the principles of the present invention. Presentation 700 is a graphical display that may be produced with a suitable display device (305 in FIG. 3) at a player station (such as EPS 103) under control of the display controller 402 shown in FIG. 4 in response to a bingo game result comprising a bonus round result. Making this presentation corresponds to the process step shown at block 508 in FIG. 5. This particular example includes six different selection options, each represented by a graphic representation 701 through 706 of a stuffed animal. These graphic representations 701 through 706 are shown at various display surface locations, that is, various locations on the surface of the display device (305 in FIG. 3), which locations may be determined randomly or in any other suitable fashion. The player is instructed to select one of the graphic representations using player controls associated with the player station. It will be noted that this example shown in FIG. 7 follows the example shown in FIG. 6 with areas 708, 709, and 710 located above the selection options, graphic representations 701 through 706. These display areas may correspond to areas 605, 606, and 607 in FIG. 6, where area 708 shows the bingo pattern achieved in the underlying bingo game, area 709 shows the bingo numbers called in the game, and area 710 shows the bonus prize associated with the selection option the player eventually selects. Other forms of the invention may simply omit areas 708, 709, and 710 and show only the selection options, in this example, stuffed animal representations 701 through 706, thus giving no indication of the pattern and ball draw of the underlying bingo game. For example, the display device could change from presenting the results of a reel-type game or a horse race to displaying the bonus game without showing the bingo game results of the underlying bingo game. Alternatively, a prize associated with the particular bingo game result may be awarded first using a presentation such as that shown in FIG. 6 or a standard bingo presentation even for a bonus round result, and the presentation could change to that illustrated in FIG. 7 to facilitate bonus round play.

As discussed above, each selection option represented by a graphic 701 through 706 is associated with a bonus prize. The bonus prizes can be selected or assigned to the selection options in any of a number of different ways within the scope of the invention. Bonus prizes may be selected in some random fashion from a pool of available prizes. Bonus prizes or a set of bonus prizes may be dictated by the bingo game result representing a bonus round result. Also, in preferred forms of the invention, several different bonus prizes are available, perhaps a different prize for each selection option. Thus, the player's choice of a selection option affects the ultimate outcome of the original game play request submitted by the player. In some implementations, one or more of the selection options may be associated with a low or no value bonus prize.

FIG. 8 shows the same presentation 700 illustrated in FIG. 7, as modified after the player makes their choice from among the various selection options presented in bonus round play according to the invention. In this example, the player has used the player controls at the player station to choose the selection option corresponding to 704 in FIG. 7. In response to the choice, the selected graphic transforms as indicated at 801 to show the bonus prize associated with that selection option, in this example a prize of 100 credits. The example in FIG. 8 also shows the information in areas 708, 709, and 710 corresponding to the bingo game result. Area 708 shows the bingo pattern achieved in the underlying bingo game, area 709 shows the bingo numbers called in the game, and area 710 shows the total number of credits won from the player's selection in bonus round play. It is also possible that the area 710 could show the cumulative total from the bingo game result added to the bonus prize awarded in response to the player's selection. The bonus prize awarded to the player does not have to be the same type received in the underlying bingo game. For example, a player may receive a number of game play credits as a prize in the underlying bingo game, but based on the prize selected in the bonus game, the player may receive a watch or other tangible item.

It should be noted that in some embodiments of the invention, the bonus round presentation may depend on the result of the underlying bingo game. For example, a straight line bingo pattern may result in a bonus round having graphics such as those shown in FIGS. 7 and 8, while an “X” bingo pattern may result in a bonus round having entirely different graphics and/or an entirely different procedure, such as a trivia game for example. The bonus games may become more interactive and complex as the probability of achieving a particular bingo pattern decreases. In addition, the pool of potential bonus prizes may change depending on the type of bonus round being played, where more valuable prizes are associated with the more complicated bonus rounds.

It should also be appreciated that the graphical presentations shown in and described with respect to FIGS. 6, 7, and 8 are disclosed only for purposes of example and are by no means the only presentations that may be used in implementing the present invention. Rather, the graphical presentations that may be used to implement the present invention are limited only by the imagination of the presentation designer. For example, rather than showing stuffed animals as selection options, the display may present closed doors that need to be opened to reveal the bonus prize, or gift-wrapped packages with the selected package being unwrapped to display the given bonus prize. Also, the presentation may provide any number of interesting and exciting graphics in the course of revealing the bonus prize after the player has made a prize selection. For example, in the bonus round example that included a number of closed doors, once the player has made the selection, the chosen door may expand on the display and the other doors may disappear from the player's view. Continuing along with this example, the presentation may show an animated person representing the player or a character for the player, who enters through the opened door and does battle with a dragon for example. The outcome of the battle and subsequent bonus prize may be correlated to the door selected.

In other embodiments the options available in bonus round play are presented to the player as a choice of participants in a contest. In one such contest-choice type embodiment, the EPS 103 graphically represents a horse race and indicates that the player is to select one of the horses in the race. In another such embodiment, the player station graphically represents a spinning wheel and indicates that the player is to select one of the numbers on the wheel. This presentation adds an aspect missing from the previously described pick-a-door arrangement. That is, according to the pick-a-door arrangement there is no indication whether there is anything better or worse about the doors that the player does not pick as compared with the door that the player does pick. However, according to the horse race embodiment, for example, responsive to receiving the player selection, the player station shows the race (contest) outcome and may show the entire race. The player station would also reveal any bonus prize associated with the race outcome consistent with the player's choice in the bonus game. Thus, the contest embodiments provide another opportunity to reveal something to the player, which tends to create more suspense and thereby better maintain or capture the player's interest. That is, there is an additional aspect of revealing whether the user's choice is a “winning” choice in terms of the racing of the horses.

It will also be appreciated that the invention is not limited to a single bonus round or to single bonus round activities such as the selection of a single object from the several objects presented as selection options. In the dragon battle animation described above, for example, a victorious outcome of the battle might end up with a presentation showing the player a second set of selection options from which to choose. The bonus prize or an additional bonus prize in this example would be revealed to the game player after the player makes a selection from this second set of selection options. In yet other implementations of the present invention the player may be required to do something more than simply picking an object or picking a contestant. For example, a player may be required to make multiple inputs to make their selection or even control a contestant in an animated contest or battle. In these multiple input selection embodiments, all of the multiple inputs may be considered the player's selection according to the invention.

Many other features may be incorporated into the animations or displays for bonus round play according to the invention. For example, a notification device or alarm associated with the player station may be activated when a bingo game result is associated with bonus round play. The notification device or alarm may draw attention to the respective player station and the following selection or selections and animation for the bonus game.

In various embodiments of the invention, the one or more software programs used to direct processor operations are implemented in various ways, including procedure-based techniques, component-based techniques or object-oriented techniques, among others. Specific examples include XML, C, C++ objects, Java, and class libraries. However, it will be appreciated that the invention is not limited to any particular hardware or software implementation.

The above-described embodiments have been presented for purposes of illustration, but are not intended to be exhaustive or to limit the invention to the forms disclosed. Many additional aspects, modifications and variations are also contemplated. Furthermore, the information or data communicated or distributed in the various processes of the present invention are capable of being distributed in a variety of forms. The present invention applies equally regardless of the particular type of signal bearing media actually used to carry out the distribution.

1. A method including:
(a) identifying a number of bingo game results for a bingo game, one of the bingo game results comprising a bonus result which is associated with a game play request initiated through a player station;
(b) in response to the bonus round result, presenting number of selection options through a display device associated with the player station;
(c) enabling a player at the player station to choose one of the selection options presented through the display device; and
(d) presenting a bonus prize to the player at the player station, the bonus prize being associated with the selection option chosen by the player.

2. The method of claim 1 wherein the bonus round result is associated with a predetermined set of potential bonus prizes, and wherein each selection option is associated with a respective one of the potential bonus prizes.

3. The method of claim 2 wherein the association between each selection option and the respective one of the potential bonus prizes is made at random.

4. The method of claim 1 further including presenting the selection options on the display device at randomly determined display surface locations.

5. The method of claim 1 wherein each selection option is randomly associated with a respective potential bonus prize after identifying the respective bingo game result comprising the bonus round result.

6. The method of claim 5 further including conducting a bonus bingo game to identify at least one of the potential bonus prizes.

7. The method of claim 5 further including assigning a result from a pool of predetermined results to identify at least one of the potential bonus prizes.

8. A gaming system including:
(a) a number of player stations;
(b) a bingo game processor for conducting a bingo game for a number of game play requests received from the player stations, for identifying a respective bingo game result for each respective game play request, and for causing the respective bingo game result for each game play request to be communicated to the player station from which the respective game play request was received, where at least one of the bingo game results comprises a bonus round result; and
(c) a respective display device and display controller associated with each respective player station, each respective display controller for causing the display device associated with the respective player station to present a number of selection options in response to the receipt of the bonus round result at that particular player station from the bingo game processor, and to display a bonus prize associated with one of the selection options chosen by a player at the respective player station.

9. The gaming system of claim 8 wherein a bonus prize controller associates the bonus round result with a predetermined set of potential bonus prizes, and wherein each selection option is associated with a respective one of the potential bonus prizes.

10. The gaming system of claim 9 wherein the bonus prize controller randomly associates each selection option with the respective one of the potential bonus prizes.

11. The gaming system of claim 9 wherein the bonus prize controller identifies the predetermined association between each selection option and the respective one of the potential bonus prizes.

12. The gaming system of claim 8 wherein the display controller randomizes the location of the selection options on a display race of the display device.

13. The gaming system of claim 8 wherein a bonus prize controller associates each selection option with a respective potential bonus prize.

14. The gaming system of claim 13 wherein a bonus bingo game is conducted to identify at least one of the potential bonus prize.

15. The gaming system of claim 13 wherein a lottery result is assigned from a pool of lottery results to identify at least one of the potential bonus prizes.

16. A product store on at least one computer readable medium, the program product including:
(a) bingo game program code adapted to be executed to conduct a bingo game for a number of game play requests and to identify a respect bingo game result for each respective game play request, at least one bingo game result comprising a bonus round result and being identified with a respective game play request received from a player station;
(b) display program code adapted to be executed to direct a display device associated with the player station to display a number of selection option and to direct the display device to display a bonus prize associated with a selection option chosen by a player at the player station; and
c) player selection program code for detecting the selection option chosen by the player.

17. The program product of claim 16 further including bonus prize program code for associating the bonus round result with a predetermined set of potential bonus prizes, wherein each selection option is associated with a respective one of the potential bonus prizes.

18. The program product of claim 16 further including bonus prize program code for associating each selection option with a respective potential bonus prize.

19. The program product of claim 16 wherein bonus prize program code or the bingo game program code conducts a bingo game to identify at least one potential bonus prize associated with a respective selection option.

20. The gaming system of claim 18 wherein the bonus prize program code assigns results from a pool of lottery results to identify at least one of the potential bonus prizes.
